(19) United States
(12) Patent Application Publication
(10) Pub. No.: US 2016/0210622 A1
(43) Pub. Date: Jul. 21, 2016

(54) PAYMENT SERVER DEVICES, PAYMENT SYSTEMS AND NON-TRANSITORY COMPUTER READABLE MEDIUMS

(71) Applicant: LINE Corporation, Tokyo (JP)

(72) Inventors: Heechan YANG, Tokyo (JP); Hideyuki KAKIUCHI, Tokyo (JP); Kenichi SUGIMOTO, Tokyo (JP)

(21) Appl. No.: 14/832,364

(22) Filed: Aug. 21, 2015

(30) Foreign Application Priority Data
Jan. 16, 2015 (JP) 2015-007144

(51) Int. Cl. G06Q 20/38; G06Q 20/40; G06Q 20/32

(52) U.S. Cl. CPC G06Q 20/3829; G06Q 20/3226; G06Q 20/405

(57) ABSTRACT

To allow transmission of payment information to a payment server device without the payment information being subjected to unauthorized rewriting, and to allow a user of a mobile terminal to confirm the payment information transmitted to the payment server device. A payment server device is provided that transmits/receives information to/from a payment terminal via a mobile terminal communicating with the payment terminal via near field communication, the payment terminal allowing offline payment.

### CROSS-REFERENCE TO RELATED APPLICATIONS

This U.S. non-provisional application claims the benefit of priority under 35 U.S.C. §119 to Japanese Patent Application No. 2015-007144, filed on Jan. 16, 2015, in the Japanese Patent Office (JPO), the entire contents of which are hereby incorporated by reference in its entirety.

### BACKGROUND

1. Field

Example embodiments of the inventive concepts relate to payment server devices, payment systems and/or non-transitory computer readable mediums.

2. Description of the Related Art

A technique is known that realizes online payment with an offline point-of-sales (POS) terminal by transmitting payment information at the offline POS terminal to a payment server by utilizing a communication function of a user's mobile terminal.

Here, in a system in which the offline POS terminal transmits the payment information to the payment server device via the mobile terminal, a store where the offline POS terminal is installed wishes to prevent unauthorized rewriting of the payment information at the mobile terminal by making the mobile terminal function as a mere relay device. On the other hand, a user of the mobile terminal wishes to issue a payment instruction after confirming, at the mobile terminal, the payment information transmitted to the payment server device.

In view of the above circumstances, it is an object of example embodiments of the inventive concepts to allow transmission of the payment information to the payment server device without the payment information being subjected to unauthorized rewriting, and to allow the user of the mobile terminal to confirm the payment information transmitted to the payment server device.

### SUMMARY

At least one example embodiment of the inventive concepts provides a payment server device transmitting/receiving information to/from a payment terminal via a mobile terminal communicating with the payment terminal over, for example, near field network communication protocols, or other short-range wireless communications protocols, the payment terminal allowing offline payment, the payment server device may include a memory having computer readable instructions stored thereon, and at least one processor configured to execute the computer readable instructions to store in the memory a decryption key for decrypting payment information encrypted by the payment terminal in association with the payment terminal, store balance information of an electronic value allowing payment with the mobile terminal in association with the mobile terminal, obtain the payment information by decrypting, with the decryption key, the encrypted payment information received via the mobile terminal, and update the balance information of the mobile terminal based on the obtained payment information, when a payment instruction is received from the mobile terminal in response to transmitting the obtained payment information to the mobile terminal.

According to at least one example embodiment, the at least one processor may be further configured to generate, when the payment information is obtained, identification information for uniquely identifying the payment information, transmit to the mobile terminal a payment request including the obtained payment information and the identification information, receive a payment instruction from the mobile terminal in response to the payment request, and update the balance information of the mobile terminal based on the received payment instruction and the obtained payment information.

According to at least one example embodiment, the at least one processor may be further configured to transmit the obtained payment information to the mobile terminal, receive a payment instruction indicating that a user approves making a payment with payment details from the mobile terminal in response to the transmitted obtained payment information, and update the balance information of the mobile terminal based on the received payment instruction.

According to at least one example embodiment, the at least one processor may be further configured to store in the memory transaction information of transaction paid at the payment terminal in association with the payment terminal, and update the encrypted transaction information of the payment terminal on the basis of the obtained payment information.

According to at least one example embodiment, the at least one processor may be further configured to store in the memory the decryption key for decrypting the payment information encrypted by the payment terminal and an encryption key for generating a decryptable code in the payment terminal in association with the payment terminal, and perform the update by encrypting, with the encryption key, a first completion notice indicating the completion of the updating, and transmitting the encrypted first completion notice to the payment terminal via the mobile terminal, when the update of the transaction information is completed.

According to at least one example embodiment, at least one processor may be further configured to perform the update by transmitting a second completion notice indicating the completion of the updating to the mobile terminal when the updating of the balance information is completed.

At least one example embodiment of the inventive concepts provides a payment system including a payment application to be installed on a mobile terminal communicating with a payment terminal via near field communication, and including a server device transmitting/receiving information to/from the payment terminal via the payment application, the payment terminal allowing offline payment, the payment system may include a server device including a memory having computer readable instructions stored thereon, and at least one processor configured to execute the computer readable instructions to store, in association with the payment terminal, a decryption key for decrypting payment information encrypted by the payment terminal, store, in association with the payment application, balance information of an electronic value allowing payment with the payment application, receive encrypted payment information from the payment application, decrypt the encrypted payment information using the decryption key, obtain the payment information from the decrypted payment information, transmit the obtained payment information to the payment application on a mobile terminal, receive a payment instruction from the mobile terminal, and update the balance information of the payment application based on the received payment instruction and the obtained payment information.

At least one example embodiment of the inventive concepts provides a non-transitory computer readable medium having embodied thereon computer readable instructions for controlling at least one processor to, when executed, may cause the at least one processor to relay, to a payment server device, payment information encrypted by a payment terminal, obtain the payment information decrypted by the payment server device, display, on the mobile terminal, a screen for transmitting a payment instruction based on the payment information in response to receiving the obtained payment information, and transmit the payment instruction to the payment server device in response to a user's operation in the screen.

At least one example embodiment of the inventive concepts provides a payment method for allowing offline payment, where the method may include storing, using at least one processor, a decryption key for decrypting payment information encrypted by a payment terminal in association with the payment terminal, storing, using the at least one processor, balance information of an electronic value allowing payment with a mobile terminal in association with the mobile terminal, obtaining, using the at least one processor, the payment information by decrypting, with the decryption key, the encrypted payment information received via the mobile terminal, transmitting, using the at least one processor, the obtained payment information to the mobile terminal, receiving, using the at least one processor, a payment instruction from the mobile terminal in response to the payment request, and updating, using the at least one processor, the balance information of the mobile terminal based on the received payment instruction and the obtained payment information.

According to at least one example embodiment, the method may include generating, using the at least one processor, when the payment information is obtained, identification information for uniquely identifying the payment information.

According to at least one example embodiment, the method may include transmitting, using the at least one processor, the obtained payment information to the mobile terminal, receiving, using the at least one processor, a payment instruction indicating that a user approves making a payment with payment details from the mobile terminal in response to the transmitted obtained payment information, and updating, using the at least one processor, the balance information of the mobile terminal based on the received payment instruction.

According to at least one example embodiment, the method may include storing, using the at least one processor, in the memory transaction information of transaction paid at the payment terminal in association with the payment terminal, and updating, using the at least one processor, the encrypted transaction information of the payment terminal on the basis of the obtained payment information.

According to at least one example embodiment, the method may include storing, using the at least one processor, the decryption key for decrypting the payment information encrypted by the payment terminal and an encryption key for generating a decryptable code in the payment terminal in association with the payment terminal, and the updating may include encrypting, with the encryption key, a first completion notice indicating the completion of the updating, and transmitting the encrypted first completion notice to the payment terminal via the mobile terminal, when the update of the transaction information is completed.

According to at least one example embodiment, the updating may include transmitting a second completion notice indicating the completion of the updating to the mobile terminal when the updating of the balance information is completed.

At least one example embodiment of the inventive concepts provides a payment terminal device that may include a memory having computer readable instructions stored thereon, at least one processor configured to execute the computer readable instructions to, store in the memory an encryption key for encrypting payment information in association with a payment server device, transmit a store identifier indicating store information to a mobile terminal, receive an input indicating payment information, encrypt the payment information using the encryption key, and transmit the encrypted payment information to the mobile terminal.

According to at least one example embodiment, the at least one processor may be further configured to store in the memory a decryption key for decrypting information encrypted by the payment server device, receive encrypted transaction result information indicating the result of the payment transaction, decrypt, using the decryption key, the received encrypted transaction result information, and display, on a display panel, the decrypted transaction result information.

According to at least one example embodiment, the at least one processor may be further configured to communicate with the mobile terminal using a near field network.

According to at least one example embodiment, the payment terminal device may be a smartphone or tablet.

At least one example embodiment of the inventive concepts provides a payment terminal device including storing, using at least one processor, an encryption key for encrypting payment information in association with a payment server device, transmitting, using at least one processor, a store identifier indicating store information to a mobile terminal, receiving, using the at least one processor, an input indicating payment information, encrypting, using the at least one processor, the payment information using the encryption key, and transmitting, using the at least one processor, the encrypted payment information to the mobile terminal.

According to at least one example embodiment, it is possible to transmit the payment information to the payment server device without the payment information being subjected to unauthorized charges and/or rewriting, and the user of the mobile terminal can confirm the payment information transmitted to the payment server device.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a configuration diagram of an example of a payment system according to at least one example embodiment;

FIG. 2 is a diagram for explaining the outline of processing by the payment system according to at least one example embodiment;

FIG. 3 is a hardware configuration diagram of an example of a mobile terminal according to at least one example embodiment;

FIG. 4 is a hardware configuration diagram of an example of a payment server device according to at least one example embodiment;

FIG. 5 is a hardware configuration diagram of an example of a payment terminal according to at least one example embodiment;

FIG. 6 is a functional block diagram of an example of the payment system according to at least one example embodiment;

FIG. 7 is a configuration diagram of an example of a store transaction table according to at least one example embodiment;

FIG. 8 is a configuration diagram of an example of a user information table according to at least one example embodiment;

FIG. 9 is a configuration diagram of an example of an encryption/decryption key table according to at least one example embodiment;

FIG. 10 is a sequence diagram showing an example of the flow of payment according to at least one example embodiment;

FIG. 11A is an image diagram showing an example of a screen displayed on the mobile terminal according to at least one example embodiment;

FIG. 11B is an image diagram showing another example of the screen displayed on the mobile terminal according to at least one example embodiment;

FIG. 11C is an image diagram showing another example of the screen displayed on the mobile terminal according to at least one example embodiment;

FIG. 11D is an image diagram showing another example of the screen displayed on the mobile terminal according to at least one example embodiment;

FIG. 12A is an image diagram showing an example of a screen displayed on the payment terminal according to at least one example embodiment; and

FIG. 12B is an image diagram showing another example of the screen displayed on the payment terminal according to at least one example embodiment.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, a detailed description will be given of some example embodiments of the inventive concepts with reference to the drawings.

### <System Configuration>

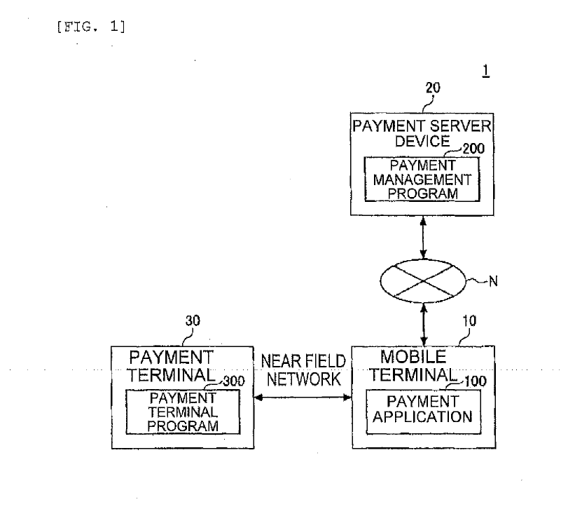

FIG. 1 is a configuration diagram of an example of a payment system according to at least one example embodiment. A payment system 1 shown in FIG. 1 includes a mobile terminal 10, a payment server device 20, and a payment terminal 30.

Here, in the payment system 1, the mobile terminal 10 and the payment server device 20 are communicatively coupled to each other via a data communication network N such as the Internet, intranet, wide area network (WAN), local area internet (LAN), personal area network (PAN), radio data network, wireless phone network, etc. Additionally, the mobile terminal 10 and the payment terminal 30 are communicatively coupled to each other via near field network communication protocols such as near field communication (NFC), Bluetooth, Bluetooth Low Energy (BLE), RFID, infrared communications, Wi-Fi, Wi-Fi Direct, etc. On the other hand, the payment terminal 30 is not coupled to the network N, and cannot directly communicate with the payment server device 20.

The mobile terminal 10 is, for example, a smartphone, a tablet terminal, a notebook PC, a smart wearable device, PDA, or the like. A payment application 100 is stored, and/or mounted (e.g., installed) on the mobile terminal 10, and a user can make a payment (settlement) for a purchased product, a rendered service, and/or monetary transfer, by using the payment application 100. On this occasion, the mobile terminal 10 relays payment information between the payment terminal 30 and the payment server device 20, and also functions as a payment instruction device for the user to confirm details of the payment and to issue a payment instruction.

The payment server device 20 is, for example, a system including one or more information processors. The payment server device 20 has installed thereon a payment management program 200, and performs a payment process on the basis of the payment information transmitted from the payment terminal 30 via the mobile terminal 10.

The payment terminal 30 is, for example, a POS terminal such as a cash register, vending machine, kiosk, etc., located or installed in a store and the like that sell products, provide services, and/or conduct monetary transfers. The payment terminal 30 has installed thereon a payment terminal program 300, and transmits the payment information to the payment server device 20 via the mobile terminal 10. It should be noted that, as described above, the payment terminal 30 is a terminal that is not coupled to the network N (that is, the payment terminal 30 is a so-called offline terminal).

It should be noted that the payment terminal 30 is not limited to the POS terminal such as the cash register installed in the store and the like, and may be a smartphone, a tablet terminal, or a notebook PC, wearable device, PDA, etc. on which the payment terminal program 300 is installed. That is, various electronic devices can be used as the payment terminal 30 that have installed thereon the payment terminal program 300 and are capable of communicating with the mobile terminal 10 via near field network communication protocols such as NFC, BLE, RFID, etc.

### <Outline of Processing>

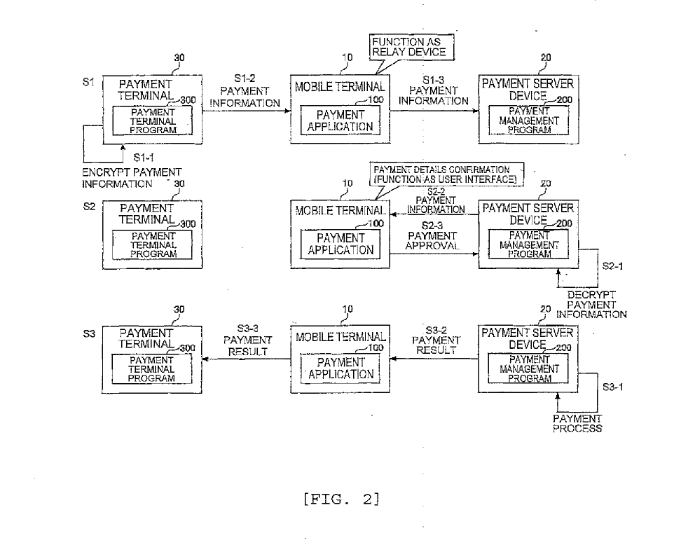

Next, a description will be given of the outline of processing by the payment system 1 according to the embodiment of the present invention. Hereinafter, a description will be given of the case where the user makes a payment, by using the mobile terminal 10, for a product or the like purchased at a store. FIG. 2 is a diagram for explaining the outline of processing by the payment system according to the embodiment of the present invention.

Step S1: first, a sales clerk of the store inputs the price of a product into the payment terminal 30. Then, the payment terminal 30 encrypts the payment information including the price of the product with, for example, a public key of the payment server device 20 (step S1-1). Next, when the user brings the mobile terminal 10 into a desired (and/or alternatively, predetermined) area from the payment terminal 30, the payment terminal 30 transmits the encrypted payment information to the mobile terminal 10 via the near field network communication protocol (step S1-2). Then, the mobile terminal 10 transmits the encrypted payment information received from the payment terminal 30 to the payment server device 20 via the network N (step S1-3). In this manner, at the stage of step S1, the mobile terminal 10 functions as a relay device that transmits the payment information transmitted from the payment terminal 30 to the payment server device 20.

Step S2: upon reception of the encrypted payment information, the payment server device 20 decrypts the encrypted payment information with its own private key (step S2-1). Then, the payment server device 20 transmits the decrypted payment information to the mobile terminal 10 (step S2-2). Next, upon reception of the payment information, the mobile terminal 10 displays a screen for prompting the user to confirm the payment details. Then, when the user approves the payment, the mobile terminal 10 transmits a payment approval to the payment server device 20 (step S2-3). In this manner, at the stage of step S2, the mobile terminal 10 functions as the payment instruction device that allows the user to confirm the payment details and to issue the payment instruction (the payment approval).

Step S3: upon reception of the payment approval from the mobile terminal 10, the payment server device 20 performs a payment process (step S3-1). Then, the payment server device 20 transmits a payment result to the mobile terminal 10 and the payment terminal 30 (step S3-2, step S3-3).

As described above, in the payment system 1 according to at least one example embodiment, the mobile terminal 10 is made to function as the mere relay device until the payment server device 20 receives the payment information. On the other hand, after the payment server device 20 receives the payment information, the mobile terminal 10 is made to function as a user interface for the user to confirm the payment details. Accordingly, it becomes possible to reduce, limit, and/or prevent the situation where unauthorized charges, rewriting or the like of the payment information is performed at the mobile terminal 10 by the user, and it also becomes possible to perform the payment process after making the user to confirm the payment details.

### <Hardware Configuration>

Next, a description is given of the hardware configurations of the mobile terminal 10, the payment server device 20, and the payment terminal 30, which are included in the payment system 1 according to at least one example embodiment.

### <Mobile Terminal>

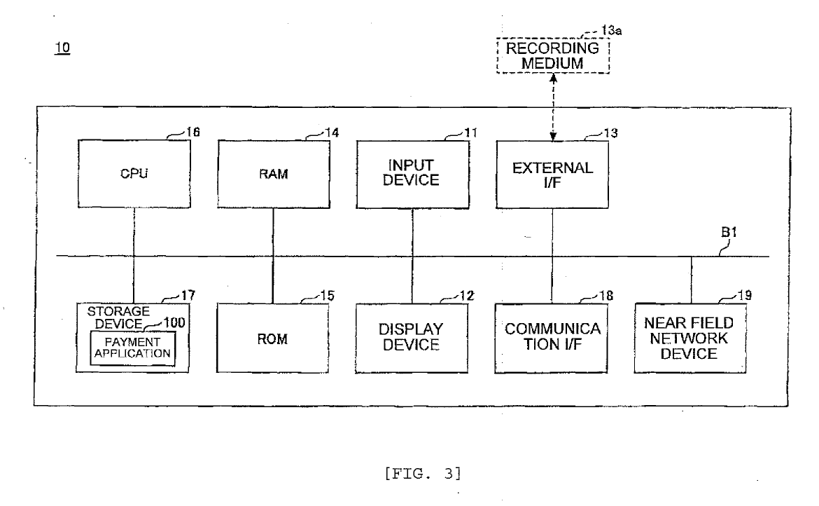

The mobile terminal 10 according to at least one example embodiment may include, for example, a hardware configuration shown in FIG. 3. FIG. 3 is a hardware configuration diagram of an example of the mobile terminal according to at least one example embodiment.

The mobile terminal 10 includes an input device 11, a display device 12, an external I/F 13, a random access memory (RAM) 14, and a read-only Memory (ROM) 15. Additionally, the mobile terminal 10 includes at least one central processing unit (CPU) 16, a storage device 17, a communication I/F 18, and a near field network device 19. These hardware components are coupled to each other via a bus B1.

The input device 11 may be a touch panel, a button, a keyboard, a mouse, a motion detection camera, or other devices used by the user to input each operation signal. The display device 12 may be a display or other devices to display a processing result by the mobile terminal 10.

The external I/F 13 is an interface with an external device. The external device may include a recording medium 13a. Accordingly, the mobile terminal 10 can perform reading and/or writing of the recording medium 13a via the external I/F 13. The recording medium 13a includes, for example, a SD memory card, a solid state drive, a hard drive, an optical disk drive, etc.

The RAM 14 is a volatile semiconductor memory temporarily holding, for example, a program and/or data. The ROM 15 is a non-volatile semiconductor memory capable of holding a program and/or data even after the power is turned off. The ROM 15 stores thereon programs and/or data for setting up an operating system (OS), a network, and the like of the mobile terminal 10.

The CPU 16 is a processing device that realizes the control and functions of the entire mobile terminal 10 by loading the program (e.g., computer readable instructions) and/or data from, for example, the ROM 15 and/or the storage device 17 into the RAM 14, and executing processes. Once the program (e.g., computer readable instructions) is loaded into the CPU 16, the CPU 16 executes the program (e.g., computer readable instructions), thereby transforming the CPU 16 into a special purpose processor. The CPU 16 may be implemented as one or more processors, one or more processor cores, a distributed processing system, a network processing system, a cloud processing system, etc.

The communication I/F 18 is an interface for coupling the mobile terminal 10 to the network N. Accordingly, the mobile terminal 10 can perform data communication with the payment server device 20 via the communication I/F 18.

The storage device 17 is a non-volatile semiconductor memory storing a program and/or data. The stored program (e.g., computer readable instructions) and/or data may include the OS, which is a basic software for controlling the entire mobile terminal 10, and an application software (for example, the payment application 100) for providing various functions on the OS.

The near field network device 19 is, for example, a NFC chip, a BLE chip, an infrared transmitter/receiver, RFID antenna, or the like, and communicates with the payment terminal 30 via the near field network.

### <Payment Server Device>

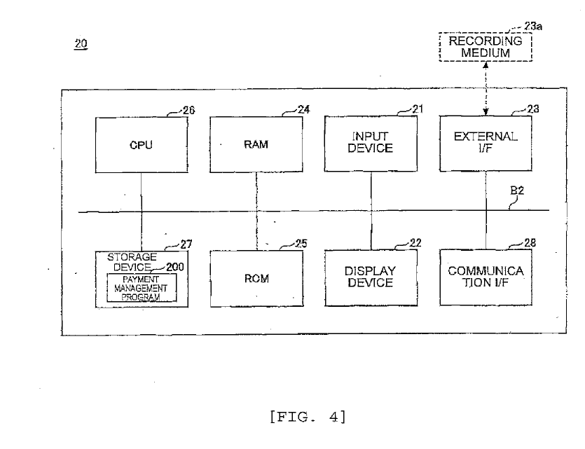

The payment server device 20 according to at least one example embodiment is realized by, for example, a hardware configuration as shown in FIG. 4. FIG. 4 is a hardware configuration diagram of an example of the payment server device according to at least one example embodiment.

The payment server device 20 includes an input device 21, a display device 22, an external I/F 23, a RAM 24, and a ROM 25. Additionally, the payment server device 20 includes a CPU 26, a storage device 27, and a communication I/F 28. These hardware components are coupled to each other via a bus B2.

The input device 21 may be a keyboard, a mouse, a mouse, a motion detection camera, or other devices used by the user to input each operation signal. The display device 22 is, for example, a display or the like, and displays a processing result by the payment server device 20. It should be noted that the input device 21 and the display device 22 may be utilized by coupling the input device 21 and the display device 22 to each other when desired or necessary.

The external I/F 23 is an interface with an external device. The external device includes, for example, a recording medium 23a. Accordingly, the payment server device 20 can perform reading and/or writing of the recording medium 23a via the external I/F 23. The recording medium 23a includes, for example, a CD, a DVD, a Blu-ray disk, a USB drive, an SD memory card, and the like.

The RAM 24 is a volatile semiconductor memory temporarily holding a program and/or data. The ROM 25 is a non-volatile semiconductor memory capable of holding a program and/or data even after the power is turned off. The ROM 25 stores thereon programs and/or data for setting up an OS, a network, and the like of the payment server device 20.

The CPU 26 is a processing device that realizes the control and functions of the entire payment server device 20 by loading the program (e.g., computer readable instructions) and/or data from, for example, the ROM 25 and/or the storage device 27 into the RAM 24, and executing processes. Once the program (e.g., computer readable instructions) is loaded into the CPU 26, the CPU 26 executes the program (e.g., computer readable instructions), thereby transforming the CPU 26 into a special purpose processor. The CPU 26 may be implemented as one or more processors, one or more processor cores, a distributed processing system, a network processing system, a cloud processing system, etc.

The communication I/F 28 is an interface for coupling the payment server device 20 to the network N. Accordingly, the payment server device 20 can perform data communication with the mobile terminal 10 via the communication I/F 28.

The storage device 27 is, for example, a hard disk drive (HDD), a solid state drive (SSD), or the like, and is a non-volatile memory storing a program and/or data. The stored program and/or data may include the OS, which is basic software for controlling the entire payment server device 20, and an application software (for example, the payment management program 200) for providing various functions on the OS.

### <Payment Terminal>

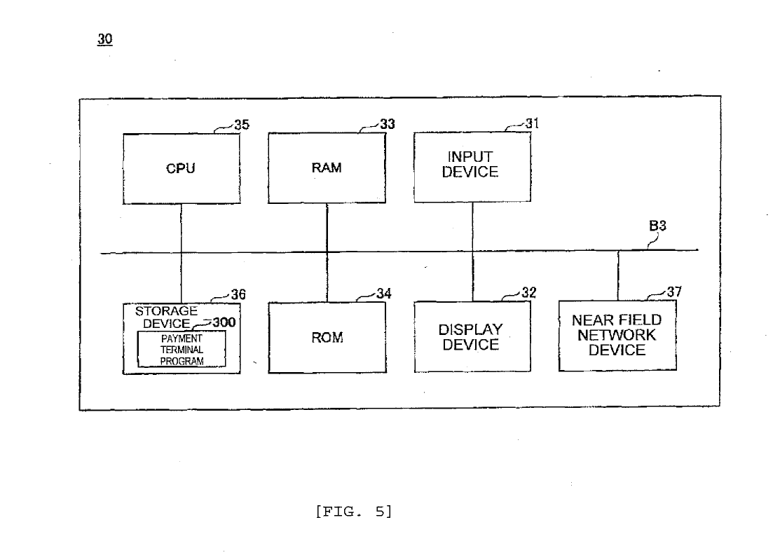

The payment terminal 30 according to at least one example embodiment is realized by, for example, a hardware configuration as shown in FIG. 5. FIG. 5 is a hardware configuration diagram of an example of the payment terminal according to at least one example embodiment.

The payment terminal 30 includes an input device 31, a display device 32, a RAM 33, and a ROM 34. Additionally, the payment terminal 30 includes a CPU 35, a storage device 36, and a near field network device 37. These hardware components are coupled to each other via a bus B3.

The input device 31 may be a touch panel, a button, a keyboard, a mouse, a motion detection camera, or other devices used by the user to input each operation signal. The display device 32 is, for example, a display or the like, and displays a processing result by the payment terminal 30.

The RAM 33 is a volatile semiconductor memory temporarily holding a program and/or data. The ROM 34 is a non-volatile semiconductor memory capable of holding a program and/or data even after the power is turned off. The ROM 34 stores thereon programs and/or data for setting up an OS and the like of the payment terminal 30.

The CPU 35 is a processing device that realizes the control and functions of the entire payment terminal 30 by loading the program (e.g., computer readable instructions) and/or data from, for example, the ROM 34 and/or the storage device 36 into the RAM 33, and executing processes. Once the program (e.g., computer readable instructions) is loaded into the CPU 35, the CPU 35 executes the program (e.g., computer readable instructions), thereby transforming the CPU 35 into a special purpose processor. The CPU 35 may be implemented as one or more processors, one or more processor cores, a distributed processing system, a network processing system, a cloud processing system, etc.

The storage device 36 is a non-volatile semiconductor memory storing a program and/or data. The stored program (e.g., computer readable instructions) and/or data may include the OS, which is basic software for controlling the entire payment terminal 30, and an application software (for example, the payment terminal program 300) for providing various functions on the OS.

The near field network device 37 is, for example, a NFC chip, a BLE chip, an infrared transmitter/receiver, RFID antenna, or the like, and communicates with the mobile terminal 10 via the near field communication.

The mobile terminal 10, the payment server device 20, and the payment terminal 30 according to some example embodiments can realize various processes, which will be described later, with the above-described hardware configurations.

### <Functional Configuration>

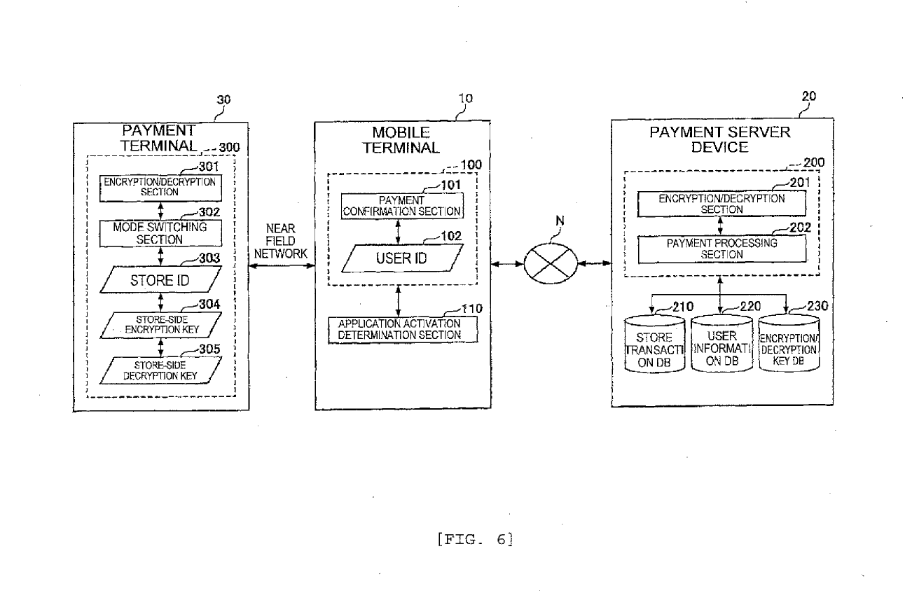

Next, a description will be given of the functional configuration of the payment system 1 according to at least one example embodiment. FIG. 6 is a functional block diagram of an example of the payment system according to at least one example embodiment.

### <Mobile Terminal>

The payment application 100 of the mobile terminal 10 includes a payment confirmation section 101 and a user ID 102. Additionally, the mobile terminal 10 includes an application activation determination section 110.

The payment confirmation section 101 is realized by, for example, executing the payment application 100 by the CPU 16, and displays, on the display device 12, a payment details confirmation screen for prompting the user to confirm the payment details.

The user ID 102 is stored in, for example, a database (not shown) on the storage device 17, and is the information for uniquely identifying the user or the mobile terminal 10 in the payment system 1.

The application activation determination section 110 is realized by, for example, the CPU 16, and determines whether or not the payment application 100 has been activated. Additionally, the application activation determination section 110 causes the display device 12 to display a desired (and/or alternatively predetermined) message in accordance with the determination result.

### <Payment Server Device>

The payment management program 200 of the payment server device 20 includes an encryption/decryption section 201 and a payment processing section 202. Additionally, the payment server device 20 includes a store transaction DB 210, a user information DB 220, and an encryption/decryption key DB 230.

The encryption/decryption section 201 is realized by, for example, executing the payment management program 200 by the CPU 26, and performs encryption or decryption of information on the basis of an encryption key or a decryption key stored in the encryption/decryption key DB 230. Here, the encryption/decryption section 201, according to some example embodiments, performs encryption and decryption with an encryption method, such as a public key encryption method. That is, the encryption/decryption section 201 of the payment server device 20 decrypts encrypted information, which is received from the payment terminal 30 via the mobile terminal 10, on the basis of the private key of the payment server device 20. Additionally, the encryption/decryption section 201 of the payment server device 20 encrypts information, which is to be transmitted to the payment terminal 30 via the mobile terminal 10, on the basis of a public key of the payment terminal 30. It should be noted that, for example, RSA encryption, MD5, SHA-1, SHA-2, PGP, GPG, Diffie-Hellman, Digital Signature Standard (DSS), ElGamal, elliptic curve algorithms, or the like may be used as the public key encryption method.

The payment processing section 202 is realized by, for example, executing the payment management program 200 by the CPU 26, and updates the store transaction DB 210 and the user information DB 220, and performs the payment process.

The store transaction DB 210 is realized by, for example, the storage device 27 or a storage device coupled to the payment server device 20 via the network N, and stores a store transaction table 210D. The details of the store transaction table 210D will be described later.

The user information DB 220 is realized by, for example, the storage device 27 or the storage device coupled to the payment server device 20 via the network N, and stores a user information table 220D. The details of the user information table 220D will be described later.

The encryption/decryption key DB 230 is realized by, for example, the storage device 27 or the storage device coupled to the payment server device 20 via the network N, and stores an encryption/decryption key table 230D. The details of the encryption/decryption key table 230D will be described later.

### <Payment Terminal>

The payment terminal program 300 of the payment terminal 30 includes an encryption/decryption section 301, a mode switching section 302, a store ID 303, a store-side encryption key 304, and a store-side decryption key 305.

The encryption/decryption section 301 is realized by, for example, executing the payment terminal program 300 by the CPU 35, and performs encryption or decryption of information on the basis of the store-side encryption key 304 or the store-side decryption key 305, respectively. Here, the encryption/decryption section 301 according to at least one example embodiment performs encryption and decryption with the public key encryption method. That is, the encryption/decryption section 301 of the payment terminal 30 encrypts information, which is to be transmitted to the payment server device 20 via the mobile terminal 10, on the basis of the public key of the payment server device 20. Additionally, the encryption/decryption section 301 of the payment terminal 30 decrypts the encrypted information, which is received from the payment server device 20 via the mobile terminal 10, on the basis of a private key of the payment terminal 30.

The mode switching section 302 is realized by, for example, the CPU 35 and the near field network device 37, and switches the communication mode of the near field network device from a first communication mode to a second communication mode in accordance with, for example, the input of the price of the product by the sales clerk of the store. In this regard, a description will be given below of the case where the near field communication by the near field network device 37 is the BLE.

(1) According to at least one example embodiment, it is assumed that the near field network device 37 is transmitting advertising packets in a surrounding area (for example, an area within 5 meters radius from the payment terminal 30) (the first communication mode). It should be noted that, as will be described later, when the mobile terminal 10 receives the advertising packet, the mobile terminal 10 can prompt the user to activate the payment application 100 of the mobile terminal 10 in accordance with the determination result of the application activation determination section 110. That is, it can be said that, in the first communication mode, the near field network device 37 functions as a beacon.

(2) In accordance with, for example, the input of the price of the product via the input device 31 of the payment terminal 30 according to at least one example embodiment, the near field near field network device 37 transmits a data packet in a surrounding area (for example, an area within 10 centimeters radius from the payment terminal 30) (the second communication mode). It should be noted that, as will be described later, the data packet includes information of, for example, the input price of the product (that is, the payment information), product and/or service information, seller information, account information, and the like. The mobile terminal 10 relays the received data packet to the payment server device 20.

As described above, the payment terminal 30 according to at least one example embodiment includes the first communication mode for functioning as the beacon, and the second communication mode for transmitting the payment information.

It should be noted that, in some example embodiments, although a description will be given of the case where the first communication mode is switched to the second communication mode, the payment terminal 30 may perform the first communication mode and the second communication mode at the same time.

The store ID 303 is stored in, for example, a database stored on the storage device 36, and is the information for uniquely identifying the store (premise) in the payment system 1.

The store-side encryption key 304 is stored in, for example, the storage device 36, and is the information utilized for encryption by the encryption/decryption section 301.

The store-side decryption key 305 is stored in, for example, the storage device 36, and is the information utilized for decryption by the encryption/decryption section 301.

<Store Transaction Table>

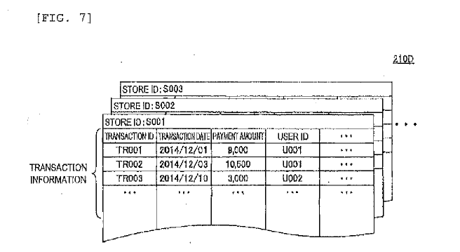

The store transaction table 210D stored in the store transaction DB 210 has a data organization as shown in FIG. 7, for example, according to at least one example embodiment. FIG. 7 is a configuration diagram of an example of the store transaction table.

The store transaction table 210D stores transaction information for each store ID. Each transaction information includes data items such as a transaction ID, a transaction date, a payment amount, and the user ID. The transaction ID is the information for uniquely identifying the transaction information. The transaction date is the date when the transaction of the product or the like is made. The payment amount (transaction amount) is the price of the product or the like for which the transaction is made. The user ID is the user ID of the user who made a payment. As described above, the store transaction table 210D stores therein, for each store, the information regarding the transaction settled by using the mobile terminal 10. For example, the transaction information with the transaction ID “TR001” of the store ID “S001” indicates that the payment of “9,000 yen” is made by a user with the user ID “U001” on the transaction date “2014/12/01”.

### <User Information Table>

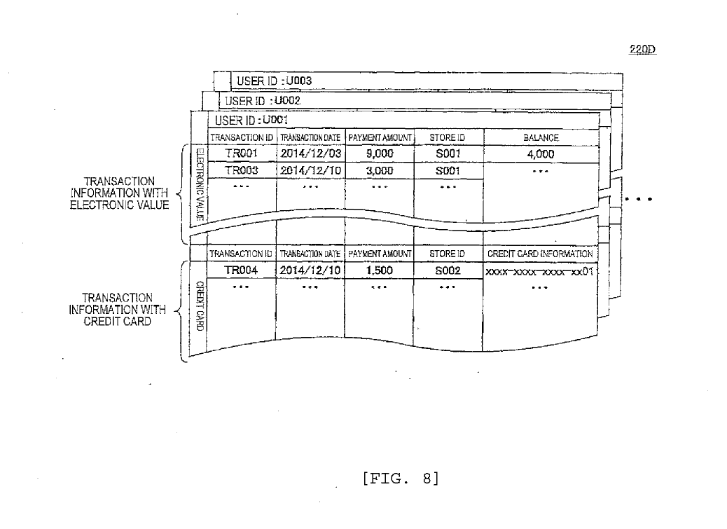

The data organization of the user information table 220D stored in the user information DB 220 is, for example, a data organization as shown in FIG. 8 according to at least one example embodiment. FIG. 8 is a configuration diagram of an example of the user information table.

The user information table 220D stores, for each user ID, the transaction information including the balance information of an electronic value and credit card information. Here, the electronic value is the amount information of the electronic money. The electronic value may be decreased by, for example, the purchase of a product, and may be increased by, for example, the deposit of the electronic money. Additionally, the credit card information is, for example, the number of a credit card used by the user for payment.

Each transaction information includes data items such as a transaction ID, a transaction date, a payment amount, and a store ID. The transaction ID, the transaction date, and the payment amount are as described above. The store ID is the store ID at which a transaction is made. For example, the transaction information in FIG. 8 indicates that the balance of the electronic value of the user with the user ID “U001” is “4,000 yen”, as a result of the payment of the transaction IDs “TR001”, “TR003”, . . . of the user ID “U001”. It should be noted that although the transaction information settled by the user with the electronic value and the transaction information paid with the credit card are recorded in the same table in FIG. 8, these information may be recorded in separate tables.

<Encryption/Decryption Key Table>

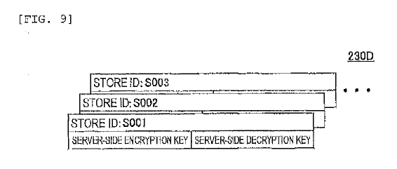

The data organization of the encryption/decryption key table 230D stored in the encryption/decryption key DB 230 is, for example, a data organization as shown in FIG. 9 according to at least one example embodiment. FIG. 9 is a configuration diagram of an example of the encryption/decryption key table.

The encryption/decryption key table 230D stores, for each store ID, a server-side encryption key and a server-side decryption key that are used by the encryption/decryption section 201 of the payment server device 20, etc. That is, for example, the server-side encryption key with the store ID “S001” is the public key of the payment terminal 30 with the store ID “S001”. In other words, the above-described server-side encryption key is the public key of the payment terminal 30 with the store ID “S001” corresponding to the store-side decryption key 305, according to at least one example embodiment.

Additionally, for example, the server-side decryption key with the store ID “S001” is the private key corresponding to the public key disclosed by the payment server device 20. In other words, the above-described server-side decryption key is the private key corresponding to the store-side encryption key 304 of the payment terminal 30 with the store ID “S001”. It should be noted that the public key of the payment server device (the store-side encryption key 304) is common to all store IDs.

As described above, the payment server device 20 stores therein, for each store ID, the server-side encryption key and the server-side decryption key according to some example embodiments.

### <Details of Processing>

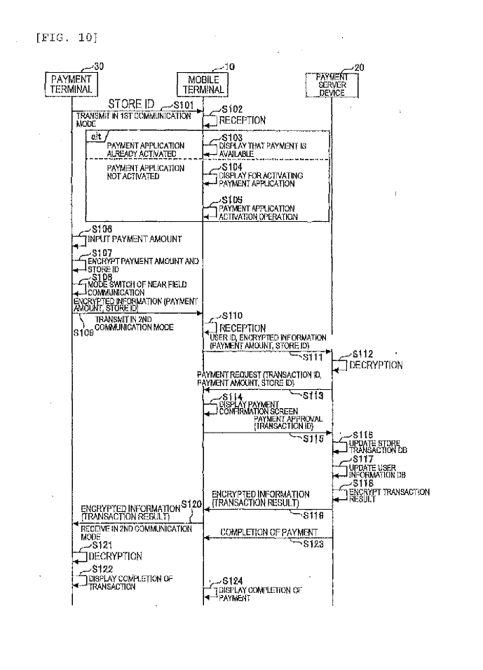

Next, a description will be given of the details of the processing by the payment system 1 according to at least one example embodiment. Hereinafter, a description will be given of the case where the user purchases a product at a store or the like, and makes a payment with the electronic value by using the mobile terminal 10. It should be noted that, hereinafter, although a description will be given by assuming that the near field communication performed between the mobile terminal 10 and the payment terminal 30 is the BLE, the example embodiments are not so limited. The near field communication may use, for example, Bluetooth, infrared data association (IrDA), Wi-Fi, Wi-Fi Direct, NFC, and/or radio frequency Identification (RFID). FIG. 10 is an exemplary sequence diagram showing the flow of payment according to at least one example embodiment.

First, the near field network device 37 of the payment terminal 30 is transmitting the advertising packet including the store ID 303 in the surrounding area (for example, the area within 5 meters radius from the payment terminal 30). That is, the near field network device 37 of the payment terminal 30 is functioning as the beacon utilizing the BLE according to the first communication mode. Here, a description will be given by assuming that the store ID 303 included in the above-described advertising packet is “S001”. It should be noted that, in the case where a smartphone or the like owned by an employee of the store is used as the payment terminal 30, instead of the store ID 303, desired (and/or alternatively predetermined) identification information may be transmitted that allows the payment server device 20 to identify the store ID 303. In this case, the payment terminal program 300 of the payment terminal 30 may not include the store ID 303.

Here, when the user of the mobile terminal 10 arrives at a position (within the above-described 5 meters radius area) where the near field communication with the payment terminal 30 is available, the near field network device 19 of the mobile terminal 10 receives the advertising packet transmitted from the payment terminal (steps S101 to S102). Then, the application activation determination section 110 of the mobile terminal 10 determines whether or not the payment application 100 is already activated.

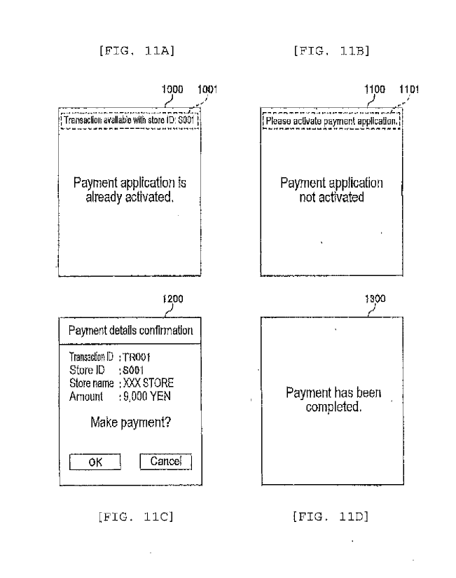

Then, when the application activation determination section 110 of the mobile terminal 10 determines that the payment application 100 is already activated, the application activation determination section 110 of the mobile terminal 10 causes the display device 12 to display, for example, a screen 1000 as shown in FIG. 11A. That is, the application activation determination section 110 displays, at a desired (and/or alternatively predetermined) position in the screen (for example, an upper portion of the screen), a message 1001 indicating that the transaction with the store having the store ID “S001” is available (step S103).

On the other hand, when the application activation determination section 110 of the mobile terminal 10 determines that the payment application 100 is not already activated, the application activation determination section 110 of the mobile terminal 10 causes the display device 12 to display, for example, a screen 1100 as shown in FIG. 11B. That is, the application activation determination section 110 displays, at the desired (and/or alternatively predetermined) position in the screen (for example, the upper portion of the screen), a message 1101 prompting the user to activate the payment application 100 (step S104). Accordingly, the user activates the payment application 100 via the input device 11 (step S105). It should be noted that the user may activate the payment application 100 by performing, for example, a tap operation and/or a flick operation on a position in the screen displaying the message 1101.

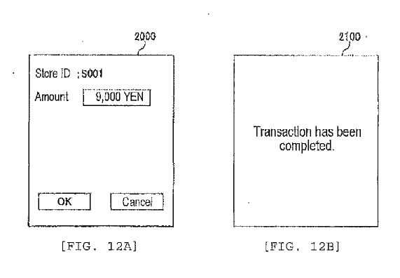

Additionally, the sales clerk or the like of the store inputs, via the input device 31 of the payment terminal 30, the price (payment amount) (here, “9,000”) of the product or the like that the user wishes to purchase (step S106). That is, for example, as shown in FIG. 12A, the sales clerk or the like inputs the payment amount in a payment amount input screen 2000, and presses an OK button. Then, the encryption/decryption section 301 of the payment terminal 30 encrypts the input payment amount and the store ID 303 on the basis of the store-side encryption key 304 (step S107). Then, the mode switching section 302 of the payment terminal 30 switches the communication mode of the near field communication to the second communication mode (step S108). Accordingly, the near field network device 37 of the payment terminal 30 transmits a data packet (that is, the payment information) including the encrypted payment amount and store ID 303 in the surrounding area (for example, the area within 10 centimeters radius from the payment terminal 30).

Here, when the user of the mobile terminal 10 arrives at a position (within the above-described 10 centimeters radius area) where the near field communication with the payment terminal 30 is available, the near field network device 19 of the mobile terminal 10 receives the data packet transmitted from the payment terminal 30 (steps S109 to S110). Then, the communication I/F 18 of the mobile terminal 10 adds its own user ID 102 (here, “U001”) to the received data packet, and transmits the data packets to the payment server device 20 via the network N (step S111). This means that the mobile terminal 10 functions as the relay device that merely relays the payment information received from the payment terminal 30.

Next, the encryption/decryption section 201 of the payment server device 20 decrypts the encrypted payment amount and store ID, which are included in the data packet received from the mobile terminal 10, on the basis of the server-side decryption key stored in the encryption/decryption key table 230D (step S112). Accordingly, the payment server device 20 obtains the payment amount and the store ID. Additionally, on this occasion, the payment server device 20 performs assignment of the transaction ID for uniquely identifying the transaction of the obtained payment amount and store ID.

Then, the communication I/F 28 of the payment server device 20 transmits a transaction request including the transaction ID, the payment amount, and the store ID to the mobile terminal 10 via the network N (step S113). Upon reception of the payment request from the payment server device 20, the payment confirmation section 101 of the mobile terminal 10 causes the display device 12 to display, for example, a payment details confirmation screen 1200 as shown in FIG. 11C (step S114). The payment details confirmation screen 1200 displayed on this occasion is a screen for prompting the user to confirm the payment details such as the store ID, the payment amount, and the like. Accordingly, the user can make a payment after confirming the payment details.

Next, for example, when the user presses an OK button after confirming the payment details in the payment details confirmation screen 1200, the communication I/F 18 of the mobile terminal 10 transmits the payment approval including the transaction ID to the payment server device 20 via the network N (step S115). It should be noted that the payment approval may include, in addition to the transaction ID, a password for authenticating the user, the store ID, and/or the payment amount.

Subsequently, upon reception of the payment approval from the mobile terminal 10, the payment processing section 202 of the payment server device 20 updates the store transaction table 210D and the user information table 220D (steps S117 to S118). That is, the payment processing section 202 adds the transaction information to the store transaction table 210D on the basis of the user ID 102 transmitted in step S111, the store ID and payment amount decrypted and obtained in step S112, and the transaction ID assigned in step S112. For example, the payment processing section 202 obtains the transaction date, such as that day's date (e.g., “2014/12/03”), or another date such as a future or past date, and thereafter adds, to the store transaction table 210D with the store ID “S001”, the transaction information with the transaction ID “TR001”, the transaction date “2014/12/03”, the payment amount “9,000”, and the user ID “U001”.

Similarly, the payment processing section 202 adds the transaction information of the electronic value to the user information table 220D on the basis of the store ID, the payment amount and the transaction ID. Further, on the basis of the user ID, the payment processing section 202 decreases the balance of the electronic value for the user ID by the payment amount. For example, in the user information table 220D for the user ID “U001”, the transaction information of the electronic value with the transaction ID “TR001”, the transaction date “2014/12/03”, the payment amount “9,000”, and the store ID “S001” is added, and then the balance is decreased by “9,000”.

The encryption/decryption section 201 of the payment server device 20 encrypts a transaction result, indicating the completion of the transaction, on the basis of the server-side encryption key for the corresponding store ID (that is, store ID “S001”) stored in the encryption/decryption key table 230D (step S118). Then, the communication I/F 28 of the payment server device 20 transmits the encrypted transaction result to the mobile terminal 10 via the network N (step S119). Additionally, the near field network device 19 of the mobile terminal 10 transmits the encrypted transaction result, which is received from the payment server device 20, to the payment terminal 30 via the near field communication (step S120).

Upon reception of the encrypted transaction result from the mobile terminal 10, the encryption/decryption section 301 of the payment terminal 30 decrypts the received encrypted transaction result with the store-side decryption key 305 (step S121), and causes the display device 22 to display, for example, a transaction completion screen 2100 as shown in FIG. 12B (step S122). Accordingly, the sales clerk or the like of the store can recognize that the transaction of the product or the like has successively been completed.

On the other hand, the communication I/F 28 of the payment server device 20 transmits, to the mobile terminal 10 via the network N, a payment completion notice indicating the completion of the payment (step S123). Then, upon reception of the payment completion notice from the payment server device 20, the mobile terminal 10 causes the display device 12 to display, for example, a payment completion screen 1300 as shown in FIG. 11D (step S124). Accordingly, the user of the mobile terminal 10 can recognize that the payment of the purchased product or the like has successively been completed.

In this manner, a series of processing from the purchase of the product or like by the user to the completion of the payment is completed in the payment system 1 according to at least one example embodiment. It should be noted that, on the basis of the store transaction DB 210 updated in the above-described step S116, transfer processing or the like is performed, for example, monthly or weekly, with respect to the store's accounts of banking institutions.

Additionally, when the smartphone or the like owned by the employee of the store is used as the payment terminal 30 in the above-described case, the smartphone or the like may be allowed to function as the payment terminal 30 as long as a desired (or alternatively predetermined) signal is received from equipment installed within the store. Accordingly, while the employee of the store can make his/her smartphone function as the payment terminal 30 when the smartphone or the like is within the store, the employee cannot make his/her smartphone or the like to function as the payment terminal 30 when the smartphone is outside the store. Therefore, it is possible to limit, reduce and/or prevent the employee of the store from performing unauthorized charges, payment, etc. by making his/her smartphone or the like function as the payment terminal 30 outside the store.

Further, in the above description, the description was given of the case where the payment was made by the user with the electronic value. However, similar processing is performed also in the case where the credit card is used. That is, in this case, in the process of the above-described step S117, the user information table 220D may be updated by adding thereto the transaction information that the payment was made with the credit card.

### CONCLUSION

As described above, in the payment system 1 according to at least one example embodiment, the mobile terminal 10 is made to function as the mere relaying device until the payment server device 20 receives the payment information regarding the transaction with the offline payment terminal 30 made by the user by using the mobile terminal 10. Accordingly, it is possible to satisfy the store's needs to limit, reduce and/or prevent falsification and the like of the payment information by the mobile terminal 10 and the like.

Additionally, in the payment system 1 according to at least one example embodiment, it is possible to satisfy the user's needs to perform the payment process after confirming the payment details by allowing, after the payment server device 20 receives the payment information, the user of the mobile terminal 10 to confirm the payment details regarding the payment information.

The example embodiments as disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may execute the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It will be apparent to those skilled in the art that various modifications and variations can be made to the example embodiments without departing from the spirit or scope of the inventive concepts described herein. Thus, it is intended that the example embodiments cover the modifications and variations of the example embodiments provided they come within the scope of the appended claims and their equivalents.

What is claimed is:

1. A payment server device transmitting/receiving information to/from a payment terminal via a mobile terminal communicating with the payment terminal via near field communication, the payment terminal allowing offline payment, the payment server device comprising:
a memory having computer readable instructions stored thereon; and
at least one processor configured to execute the computer readable instructions to,
store in the memory a decryption key for decrypting payment information encrypted by the payment terminal in association with the payment terminal,
store balance information of an electronic value allowing payment with the mobile terminal in association with the mobile terminal,
obtain the payment information by decrypting, with the decryption key, the encrypted payment information received via the mobile terminal,
transmit the obtained payment information to the mobile terminal,
receive a payment instruction from the mobile terminal in response to the payment request; and
update the balance information of the mobile terminal based on the received payment instruction and the obtained payment information.

2. The payment server device according to claim 1, wherein the at least one processor is further configured to:
generate, when the payment information is obtained, identification information for uniquely identifying the payment information.

3. The payment server device according to claim 1, wherein the at least one processor is further configured to:
transmit the obtained payment information to the mobile terminal;
receive a payment instruction indicating that a user approves making a payment with payment details from the mobile terminal in response to the transmitted obtained payment information; and
update the balance information of the mobile terminal based on the received payment instruction.

4. The payment server device according to claim 1, wherein the at least one processor is further configured to:
store in the memory transaction information of transaction paid at the payment terminal in association with the payment terminal; and
update the encrypted transaction information of the payment terminal on the basis of the obtained payment information.

5. The payment server device according to claim 4, wherein the at least one processor is further configured to:
store in the memory the decryption key for decrypting the payment information encrypted by the payment terminal and an encryption key for generating a decryptable code in the payment terminal in association with the payment terminal; and
perform the update by,
encrypting, with the encryption key, a first completion notice indicating the completion of the updating, and
transmitting the encrypted first completion notice to the payment terminal via the mobile terminal,
when the update of the transaction information is completed.

6. The payment server device according to claim 1, wherein the at least one processor is further configured to perform the update by transmitting a second completion notice indicating the completion of the updating to the mobile terminal when the updating of the balance information is completed.

7. A payment system including a payment application to be installed on a mobile terminal communicating with a payment terminal via near field communication, and including a server device transmitting/receiving information to/from the payment terminal via the payment application, the payment terminal allowing offline payment, the payment system comprising:
a server device including,
a memory having computer readable instructions stored thereon; and
at least one processor configured to execute the computer readable instructions to,
store, in association with the payment terminal, a decryption key for decrypting payment information encrypted by the payment terminal;
store, in association with the payment application, balance information of an electronic value allowing payment with the payment application;
receive encrypted payment information from the payment application;
decrypt the encrypted payment information using the decryption key;
obtain the payment information from the decrypted payment information;
transmit the obtained payment information to the payment application on a mobile terminal;
receive a payment instruction from the mobile terminal; and
update the balance information of the payment application based on the received payment instruction and the obtained payment information.

8. A payment method for allowing offline payment, the method comprising:
storing, using at least one processor, a decryption key for decrypting payment information encrypted by a payment terminal in association with the payment terminal;
storing, using the at least one processor, balance information of an electronic value allowing payment with a mobile terminal in association with the mobile terminal;
obtaining, using the at least one processor, the payment information by decrypting, with the decryption key, the encrypted payment information received via the mobile terminal;
transmitting, using the at least one processor, the obtained payment information to the mobile terminal;
receiving, using the at least one processor, a payment instruction from the mobile terminal in response to the payment request; and
updating, using the at least one processor, the balance information of the mobile terminal based on the received payment instruction and the obtained payment information.

9. The method according to claim 8, further comprising:
generating, using the at least one processor, when the payment information is obtained, identification information for uniquely identifying the payment information.

10. The method according to claim 8, further comprising:
transmitting, using the at least one processor, the obtained payment information to the mobile terminal;
receiving, using the at least one processor, a payment instruction indicating that a user approves making a payment with payment details from the mobile terminal in response to the transmitted obtained payment information; and
updating, using the at least one processor, the balance information of the mobile terminal based on the received payment instruction.

11. The method according to claim 8, further comprising:
storing, using the at least one processor, in the memory transaction information of transaction paid at the payment terminal in association with the payment terminal; and
updating, using the at least one processor, the encrypted transaction information of the payment terminal on the basis of the obtained payment information.

12. The method according to claim 8, further comprising:
storing, using the at least one processor, the decryption key for decrypting the payment information encrypted by the payment terminal and an encryption key for generating a decryptable code in the payment terminal in association with the payment terminal; and
the updating including,
encrypting, with the encryption key, a first completion notice indicating the completion of the updating, and
transmitting the encrypted first completion notice to the payment terminal via the mobile terminal,
when the update of the transaction information is completed.

13. The method according to claim 8, wherein the updating includes transmitting a second completion notice indicating the completion of the updating to the mobile terminal when the updating of the balance information is completed.

14. A payment terminal device comprising:
a memory having computer readable instructions stored thereon; and
at least one processor configured to execute the computer readable instructions to,
store in the memory an encryption key for encrypting payment information in association with a payment server device,
transmit a store identifier indicating store information to a mobile terminal,
receive an input indicating payment information,
encrypt the payment information using the encryption key, and
transmit the encrypted payment information to the mobile terminal.

15. The payment terminal device according to claim 14, wherein the at least one processor is further configured to:
store in the memory a decryption key for decrypting information encrypted by the payment server device;
receive encrypted transaction result information indicating the result of the payment transaction;
decrypt, using the decryption key, the received encrypted transaction result information; and
display, on a display panel, the decrypted transaction result information.

16. The payment terminal device according to claim 14, wherein the at least one processor is further configured to communicate with the mobile terminal using a near field network.

17. The payment terminal device according to claim 14, wherein the payment terminal device is a smartphone or tablet.

18. A payment method comprising:
storing, using at least one processor, an encryption key for encrypting payment information in association with a payment server device;
transmitting, using at least one processor, a store identifier indicating store information to a mobile terminal;
receiving, using the at least one processor, an input indicating payment information;
encrypting, using the at least one processor, the payment information using the encryption key; and
transmitting, using the at least one processor, the encrypted payment information to the mobile terminal.
